(19) United States
(12) Patent Application Publication
(10) Pub. No.: US 2008/0108439 A1
(43) Pub. Date: May 8, 2008

(54) Cooling configuration for gaming machine display

(76) Inventor: Joseph W. Cole, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 11/594,514

(22) Filed: Nov. 7, 2006

(51) Int. Cl. A63F 13/08

(52) U.S. Cl. 463/46; 165/120; 361/695

(57) ABSTRACT

A gaming device comprises a housing and a generally horizontally mounted thin-panel display. The gaming device includes a display cooling air system. The system includes a plenum leading to one or more passages or openings in a housing of the display which lead to the interior of the display. One or more air delivery devices, such as fans, are used to draw air into the plenum and deliver it through the passages to the interior of the display. The air is then routed out of the display through other passages or openings. In another configuration, the fans may be used to draw air through the interior of the display and exhaust it through the plenum. The plenum may be mounted directly to a rear or back of the housing of the display.

### FIELD OF THE INVENTION

The present invention is cooling configuration for a display and, more particularly, a gaming machine display.

### BACKGROUND OF THE INVENTION

Liquid crystal (LCD), plasma and similar thin-panel displays are now commonly used in the television industry and as displays for computing devices. These types of displays are now being utilized in other settings, such as in gaming devices. For example, U.S. Pat. No. 6,475,087 discloses a gaming machine having a thin-panel display which is mounted to a door of the gaming machine.

As these displays have been utilized in other settings, certain problems have been encountered. One problem is damage to the display due to vibration or exposure to other forces. Yet another problem is cooling of the display to ensure its longevity.

### SUMMARY OF THE INVENTION

The present invention is an air cooling system for a display device. The air cooling system has particular utility to a horizontally or generally horizontally positioned thin-panel display, such as a LCD, LED or plasma display. In one embodiment, the air cooling system is associated with a display utilized in a gaming machine.

In one embodiment, the air cooling system comprises a plenum and a means for moving air. The plenum defines an air path leading to or from the display and, in particular, at least one passage leading to an interior of the display. The means for moving air preferably forces air through the plenum to the interior of the display, or draws air from the interior of the display.

The plenum may comprise a body which is configured to be mounted to a housing portion of the display. The body preferably defines at least one air passage leading therethrough and cooperates with the housing portion of the display to define an air space. In one embodiment, one or more fans are associated with the body, such as by being located at each passage leading therethrough to the air space.

In this configuration, the air space is in communication with at least one passage leading to the interior of the display, such as by having the body located over the one or more passages. Preferably, one or more other passages lead through the housing portion of the display which are not associated with the plenum.

The one or more fans or other means for moving air may, in one configuration, draw air through one or more passages through the housing portion of the display to the interior of the display. In this configuration, these passages through the housing portion serve as air intake passages. The air is then drawn through one or more passages in the housing to the air space of the plenum, from which the air is exhausted through the air passages of the plenum to point external thereto. In this configuration, the one or more passages leading through the housing portion of the display to the plenum comprise air exit or exhaust passages.

In another embodiment, the one or more fans or other means for moving air may be configured to draw cooling air through the air passages in the body to the air space of the plenum. This air may then be forced into the interior of the display. The air is then forced through the one or more passages which are not associated with the plenum to a point external to the display.

In accordance with the invention, the cooling air system forcibly moves cooling air from a point external to the display through at least a portion of the interior of the display. In this manner, the display, including various internally located components, is cooled.

For a fuller understanding of the nature and advantages of the present invention over the prior art, reference should be made to the ensuing detailed description and claims, taken in conjunction with the accompanying drawings.

### DESCRIPTION OF THE DRAWINGS

FIG. 1 is a perspective view of a gaming device including a display, the gaming device comprising one environment of use for the display air cooling system of the invention;

FIG. 2 is a front perspective view of a display of the type which maybe cooled with the air cooling system of the invention;

FIG. 3 is a perspective exploded rear view of the display illustrated in FIG. 2, the display including a cooling air system;

FIG. 4 is a partial exploded view of a plenum and fan of the cooling air system illustrated in FIG. 3; and

FIGS. 5A and 5B are schematic side views of a display of the invention illustrating display cooling air pathways.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have been indicated but not described in detail so as not to obscure the invention.

In one embodiment, the invention is a cooling configuration for a display and, more particularly, a thin-panel type display. The invention has particular utility to thin-panel displays which are oriented horizontally or substantially horizontally.

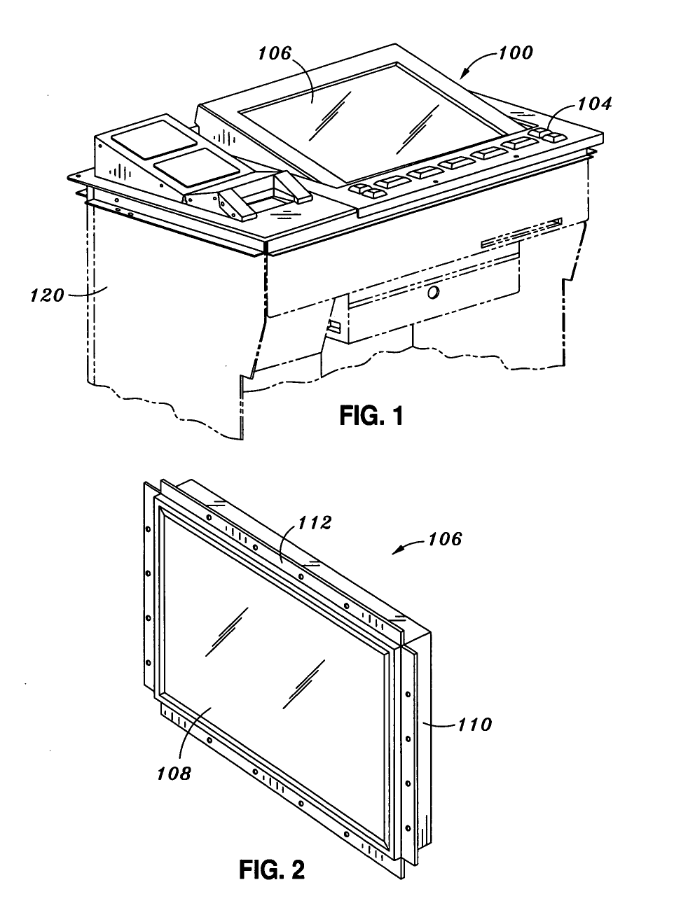

One environment of use of such a display is a gaming device. For example, FIG. 1 illustrates a table or “bar”-top gaming device 100. In general, the gaming device 100 comprises a housing or cabinet 102 for supporting and/or enclosing various components of the gaming device. The cabinet 10 may have a variety of shapes and configurations. As illustrated, the cabinet 102 includes a top 104. In one configuration, one or more portions of the top 104 are configured as a door, thereby permitting access to a generally enclosed interior area of the cabinet 102.

The gaming device 100 includes at least one display device 106. In one embodiment, the display device 106 is mounted to the top 104 of the cabinet 102. In other embodiments, the display device 106 may be mounted so as to simply be viewed through an opening or window in the top 104.

In a preferred embodiment, the display device 106 comprises a thin-panel electronic video display such as a LCD, a LED, plasma, or similar display. As illustrated, because the gaming device 100 is a table or bar-top type device, the display 106 is oriented horizontally or substantially horizontally. In the configuration illustrated, the display 106 angles upwardly, such that it lies in a plane which extends approximately 20 degrees from horizontal. In other embodiments, however, the display 100 might be mounted completely horizontally.

Of course, the gaming device 100 may include a variety of other features, as are well known in the art of gaming devices or machines. For example, the gaming device 100 may includes one or more player input devices, a currency or coin acceptor for accepting currency from a player for use as a wager, and a gaming controller (including video display controller).

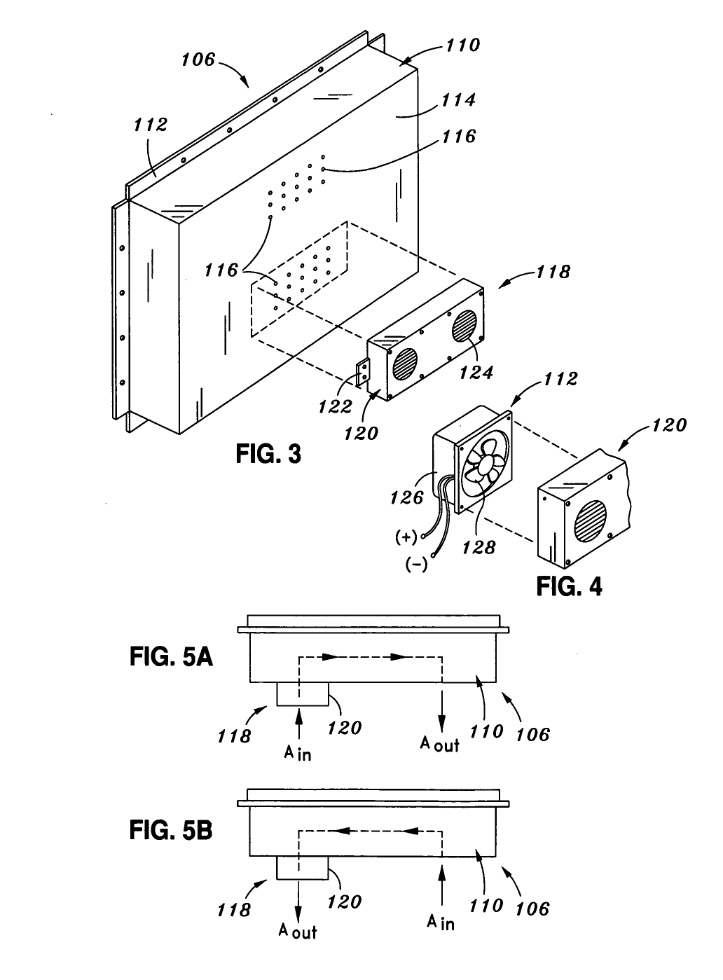

One aspect of the invention is a cooling configuration or cooling air system for a display. FIGS. 2 and 3 illustrate one embodiment of the display 106 with an associated air cooling system. As illustrated in FIG. 2, the display 106 has a front display area or window 108 and a rear housing 110. Various components of the display are located in the housing 110. In general, as is well known in the art of these types of displays 106, the display 106 is configured to display information, such as areas of light, in one or more locations of the display window 108. When properly controlled, the display 106 displays images, such as text, graphics, moving images or the like.

In one embodiment, one or more flanges 112 or other mounts may be associated with the housing 110. These flanges or mounts 112 may be used to connect the display 106 to a support structure. For example, fasteners (such as screws, bolts or the like) may be used in conjunction with the flanges 112 to mount the display 106 to the top or door 104 of the gaming device 100, as illustrated in FIG. 1.

Referring to FIG. 3, the housing 110 preferably defines at least a portion of the display 106 generally opposite the display window 108. In one embodiment, the housing 110 defines a rear portion of the display 106. The housing 110 has an exterior surface 114. In one embodiment, one or more passages or apertures 116 are defined through the housing 110 from the exterior to an interior thereof. The passages 116 may be located in various positions. In one embodiment, one or more of the passages 116 extend though the rear 114 of the housing 110.

In accordance with the invention, means are provided for delivering or forcing air through one or more of the passages 116 into the interior of the display 106 for cooling the display. In one embodiment, this means comprises a forced cooling air unit or system 118.

Referring to FIGS. 3 and 4, in one embodiment, the forced cooling air unit or system 118 comprises a plenum 120 and one or more air delivery devices 122. As illustrated, the plenum 120 comprises a housing or body which is configured to extend over one or more of the passages 116 in the housing 110 of the display 106. In one embodiment, the plenum 120 comprises one or more walls which define at least one air passage.

As illustrated, the plenum 120 is configured to be mounted to the housing 110 of the display 106 in a position that it extends over or about one or more of the passages 116. As illustrated, the plenum 120 may include one or more mounts 122 for this purpose. One or more fasteners (such as screws) may be passed through the mount(s) 122 into engagement with the housing 110 for connecting the plenum 120 to the display 106. In a preferred embodiment, the plenum 120 cooperates with the housing 110 of the display 106 to define an air space which is in communication with the one or more passages 116 in the housing 110.

As indicated, the plenum 120 defines at least one air passage. In one embodiment, the plenum 120 defines one or more air passages 124. As illustrated, two passages 124 are located in a rear wall of the plenum 120. There may be as few as one, or more than two, passages 124, and they may be in various locations and be of various shapes and sizes. The one or more air passages 124 preferably lead into the interior space of the plenum.

As illustrated, one or more air delivery devices 112 are configured to move air through the air passages in the plenum 120. In a preferred embodiment, each air delivery device 112 comprises an electrically powered fan. In one embodiment, each fan includes a housing 126, impeller 128, and motor (not visible).

In a preferred embodiment, an air delivery device 112 is associated with each air passage 124. In particular, a fan is positioned adjacent each air intake 124 for forcing air through the intake. As illustrated, the fans may be located at the interior of the plenum 120 (so as to be hidden from view and protected from damage), such as by mounting them to an interior of the rear wall of the plenum 120.

Referring to FIG. 5A, in one embodiment, the one or more air delivery devices 112 are configured to draw air from a point exterior to the plenum 120 (and the display 106) through the one or more air passages 124. This air is forced into the air space in the plenum 120. Because this air is at a higher pressure than the air outside of the plenum 120, the air naturally flows through the one or more passages 116 in the housing 110 of the display 106 over which the plenum 120 is mounted. This air flows through the interior of the display 106, cooling the internal components. The air then exits the display 106 through one or more passages 116 through the housing 110 of the display 106 with which the plenum 120 is not associated. In this regard, it is necessary for there to be one or more passages 116 or other air exits that the plenum 120 does not cover, in order for those passages to comprise air exits.

Referring to FIG. 5B, the air delivery devices 112 maybe configured to draw air through the display 106 to the interior of the plenum 120, and then expel it through the air passages 124. This may be accomplished, for example, by causing the fans to rotate in an opposing direction to that necessary to cause them to move air in the direction described above and illustrated in FIG. 5A. In this configuration, air is drawn from a point exterior to the display 106 through one or more passages 116 (which are not associated with the plenum 120) into the interior of the display 106. The air is then drawn from the interior of the display 106 to the interior of the plenum 120, from which the air is exhausted to a point exterior to the plenum 120.

Various aspects of the invention will now be appreciated. One aspect of the invention is a forced air cooling system for a display. The forced air cooling system is configured to deliver cooling air to the interior of a thin-panel display for cooling the various components thereof. The invention has particular utility to such displays which are mounted horizontally or generally horizontally. In particular, in such an orientation, convective cooling which might otherwise naturally occur as a result of warmer air flowing upwardly through the display is prevented. The air cooling system of the invention, however, overcomes this problem by forcing air through the display.

The invention also has particular utility to gaming machines or devices. As indicated above, such devices may comprise bar or table-top gaming machines. However, they may comprise other configurations of gaming devices, such as gaming tables with displays. For example, some table-type casino games (such as poker) are now presented at tables which incorporate one or more displays in their horizontal playing surface.

The cooling configuration of the invention may have a variety of other configurations than as illustrated in the figures. In one embodiment, the cooling air unit or system might comprise more than plenum. For example, the unit might comprise two plenums, each of which is associated with one or more passages into the housing of the display. There might be one or more than one fan associated with each of these plenums.

As illustrated, the plenum is mounted over one or more passages leading to the interior of the housing. The plenum might be otherwise associated with the one or more passages, such as via a hose or the like. The plenum may have a variety of configurations. For example, the plenum might be tubular, with the fan mounted in the tube and the tube having an open end and a end mounted over the one or more passages. In another embodiment, the fan may include an integral housing or plenum which can be mounted directly to the housing.

The unit might comprise other means for moving air. For example, there might be as few as one fan or more than two fans. Other means might also be utilized to create high and low air pressure areas for causing air to move through the interior of the display.

Generally, the housing of a pre-assembled display of the type detailed herein includes one or more passages leading into the interior space thereof. If there are no such passages or there are two few of those passages or their location is inconvenient, one or more passages may be formed in the housing. The passages which are utilized to allow cooling air to flow into and out of the interior of the housing maybe of a variety of shapes and sizes, and locations. The location of the plenum(s) and their shape and size may depend upon the number and location of the passages through the housing.

In one embodiment, the plenum need not be a specifically configured housing which is attached directly to the housing of the display. For example, in embodiment where the display is associated with a gaming machine housing, the gaming machine housing may define or comprise the plenum. In one embodiment, a wall or other divider may be used to segment the interior (or a part of the interior) of the gaming machine into a first area and a second area. Fan or other devices could be used to draw air from one interior area of the gaming machine (or from a point external thereto) into the interior of the housing of the display, and then cause it to be exhausted to the other interior area of the gaming cabinet (or to a point exterior thereto).

It is also possible for the housing of the display to be specifically manufactured to define a plenum. The present invention, however, has particular utility to existing displays. In particular such displays can generally be used without modification in their traditional vertical orientation. The present invention permits those displays to be used in a horizontal position.

It will be understood that the above described arrangements of apparatus and the method there from are merely illustrative of applications of the principles of this invention and many other embodiments and modifications may be made without departing from the spirit and scope of the invention. Therefore, the above should not be construed as limiting the invention as defined in the claims.

What is claimed is:

1. A gaming machine comprising:
a housing;
a thin-panel display supported by said housing, said thin panel display having a front display surface and a rear housing, said housing at least partially defining an interior of said display, said display mounted so that said front display surface is generally horizontally extending, said housing defining at least two passages leading from a point external to said housing to said interior of said display; and
a display cooling system comprising a plenum, said plenum comprising a body mounted to said housing of said display, said body defining at least one air passage, said plenum mounted over at least one of said passages in said housing, but leaving at least one passage exposed, and including at least one air delivery device mounted to said body and configured to cause air to move along a path through said at least one air passage through said body, through said at least one passage in said housing over which said plenum extends, through at least a portion of said interior of said display, and through said at least one exposed passage through said housing.

2. The gaming machine in accordance with claim 1 wherein said gaming machine comprises a gaming table having a generally horizontal play surface and said front display surface of said display is mounted generally parallel to said play surface.

3. The gaming machine in accordance with claim 1 wherein said thin panel display is selected from the group consisting of: a LED display, a LCD display and a plasma display.

4. The gaming machine in accordance with claim 1 wherein said body is mounted to said rear housing and cooperates therewith to define an air space.

5. The gaming machine in accordance with claim 4 wherein said at least one air delivery device comprises a fan which is located in said air space.

6. The gaming machine in accordance with claim 1 wherein said at least one air delivery device is configured to draw air through said at least one air passage in said body and cause air to flow through said at least one passage over which said plenum extends, through said interior of said display and exits said at least one exposed passage through said housing.

7. The gaming machine in accordance with claim 1 wherein said at least one air delivery device is configured to draw air through said at least one exposed passage through said housing, through said interior of said display and through said at least one passage over which said plenum extends to said plenum.

8. The gaming machine in accordance with claim 1 wherein said body defines a pair of air passages and an air delivery device is associated with each air passage.

9. A method of cooling a generally horizontally mounted thin-panel display of a gaming machine comprising:
mounting an air plenum comprising a body defining at least air passage to a housing portion of said display, said body connected to said housing portion of said display so that said plenum cooperates with said housing portion to define an air space, said air space in communication with at least one passage leading through said housing portion of said display to an interior portion of said display;
providing at least one fan in association with said plenum; and
utilizing said fan to move air through said plenum to or from said interior portion of said display.

10. The method in accordance with claim 9 wherein said fan draws air through at least one intake passage to said interior portion of said display and then through said at least one passage leading to said air space.

11. The method in accordance with claim 9 wherein said fan forces air from said air space through said at least passage leading to said interior portion of said display.
